(19) United States
(12) Patent Application Publication
(10) Pub. No.: US 2015/0306968 A1
(43) Pub. Date: Oct. 29, 2015

(54) ELECTRIC POWER MANAGEMENT DEVICE, ELECTRIC POWER CONTROL METHOD, AND MOBILE UNIT

(71) Applicant: Panasonic Intellectual Property Management Co., Ltd., Osaka (JP)

(72) Inventors: YUKI OHIRA, Tokyo (JP); SHOICHI TOYA, Hyogo (JP); TATSUTO KINJO, Osaka (JP); MIKIKO MATSUO, Nara (JP); HIROKI HARA, Osaka (JP); HIDESHI AOKI, Osaka (JP)

(21) Appl. No.: 14/684,472

(22) Filed: Apr. 13, 2015

(30) Foreign Application Priority Data
Apr. 24, 2014 (JP) 2014-090642

(51) Int. Cl. B60L 11/18; H02J 7/00; G06Q 30/02; H02J 1/00

(52) U.S. Cl. CPC B60L 11/1848; H02J 1/00; H02J 7/0068; G06Q 30/0208

(57) ABSTRACT

An electric power management device is an electric power management device that is provided in a facility connected to an electric power system and connects to a mobile unit provided with a power generator and an electricity storage device and includes a receiver operative to accept an instruction for selecting one of a first mode in which generated electric power of the power generator is preferentially supplied to an outside of the mobile unit and a second mode in which the electricity storage device is preferentially charged with the generated electric power of the power generator and control circuitry operative to change a supply destination of the generated electric power of the power generator in accordance with the instruction accepted by the receiver.

### BACKGROUND

1. Technical Field

The present disclosure relates to an electric power management device that performs electric power control of a facility by using electric power of a mobile unit.

2. Description of the Related Art

In recent years, the use of electric power-driven cars such as an electric car and a hybrid car has been increased, and service using these cars has been proposed. For example, there is service that suppresses the electric rate by charging an electric car during the course of the night and supplying the electric power of the electric car to household electrical appliances if the electric car is not used during the day.

As an electric car utilization method, as described in Japanese Unexamined Patent Application Publication No. 2009-183086, a method of supplying the electric power stored in an electric car to system electric power is described.

### SUMMARY

Incidentally, an attempt to achieve more effective utilization of electric power or improvement of convenience by using such an electric car has been made.

One non-limiting and exemplary embodiment provides an electric power management device that performs a new effective electric power utilization method using an electric car.

In one general aspect, the techniques disclosed here feature an electric power management device that is provided in a facility connected to an electric power system and connects to a mobile unit provided with a power generator and an electricity storage device, the electric power management device including: a first receiver operative to accept an instruction for selecting one of a first mode in which generated electric power of the power generator is preferentially supplied to an outside of the mobile unit and a second mode in which the electricity storage device is preferentially charged with the generated electric power of the power generator; and control circuitry operative to change a supply destination of the generated electric power of the power generator in accordance with the instruction accepted by the first receiver.

With the above-described configuration, since it is possible to use the generated electric power of a mobile unit provided with a power generator on the facility side, the convenience of the operation of a facility is increased.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a system configuration diagram;

FIG. 2 is an external view of an electric power management device;

FIG. 3 is a block diagram depicting the functional configuration of the electric power management device;

FIG. 4 is a block diagram depicting the functional configuration of a mobile unit;

FIG. 5A is a transition example of the amount of electric power used before load leveling and FIG. 5B is a transition example of the amount of electric power used after load leveling;

FIG. 6 is a data conceptual diagram of a management table;

FIG. 7 is a flowchart depicting the operation of the electric power management device;

FIG. 8 is a flowchart depicting the operation of the mobile unit;

FIG. 9 is a flowchart depicting an incentive calculation operation which is performed by the electric power management device;

FIG. 10 is an interface screen example;

FIG. 11 is an interface screen example;

FIG. 12 is an interface screen example;

FIG. 13 is an interface screen example; and

FIG. 14 is an interface screen example.

### DETAILED DESCRIPTION

### Embodiment 1

### Configuration

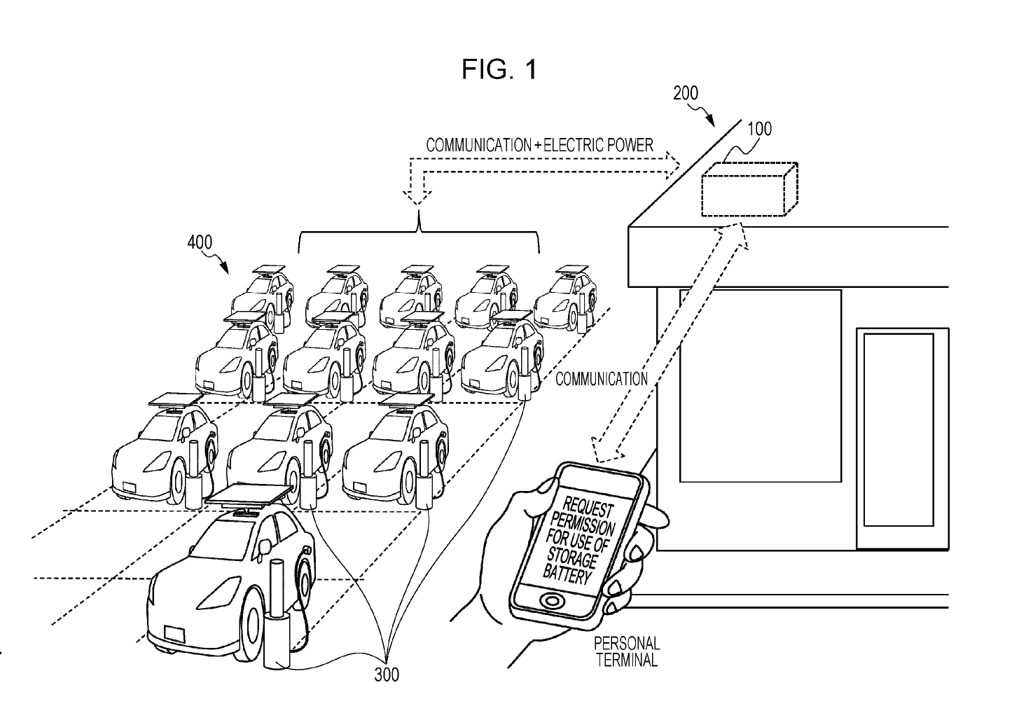

FIG. 1 is a configuration example of an electric power management system including an electric power management device 100.

As depicted in FIG. 1, the electric power management system includes the electric power management device 100, a facility 200, and a charging and discharging device 300, and a connector of the charging and discharging device 300 is connected to a mobile unit 400 in a detachable and attachable manner.

In FIG. 1, the electric power management device 100 is connected to the facility 200 and each charging and discharging device 300. The electric power management device 100 controls each charging and discharging device 300 and controls a supply of electric power to the mobile unit 400 and reception of electric power from the mobile unit 400 via the charging and discharging device 300.

The facility 200 is a facility that consumes electric power and is, as an example, an amusement park such as a recreation park or a commercial facility such as a shopping mall.

The charging and discharging device 300 is connected to the mobile unit 400 in a detachable and attachable manner and supplies electric power of an electric power system to the mobile unit 400 from the facility 200 in such a way that the mobile unit 400 is charged therewith and supplies electric power generated by a power generator (photovoltaics (PV)), a fuel cell, or the like) of the mobile unit 400 to each facility apparatus of the facility 200.

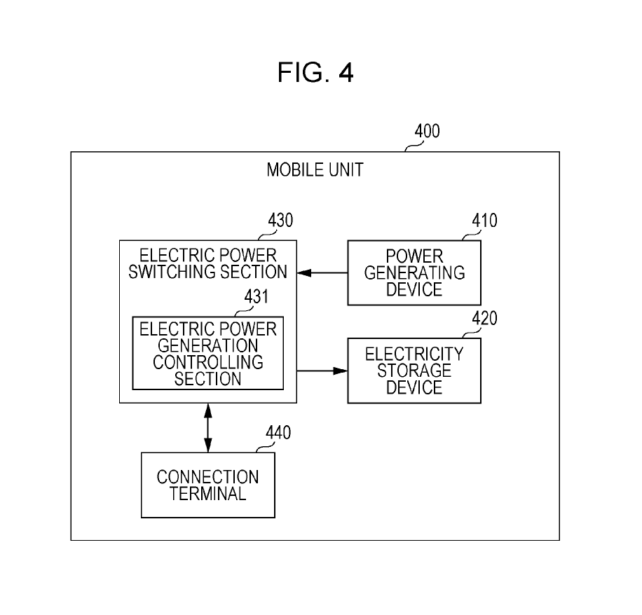

The mobile unit 400 is a vehicle that can be driven by electric power, such as a so-called electric car or hybrid car, which is called an electronic vehicle (EV), a plug-in hybrid vehicle (PHV), or the like. Although the details will be described later, as depicted in FIG. 4, the mobile unit 400 includes a power generator 410 that generates electric power, an electricity storage device 420 that stores the electric power, and an electric power switching section 430 that performs electric power supply control.

As depicted in FIG. 1, this embodiment assumes a type of usage in which the user who uses the facility 200 parks, in a parking lot provided in the facility 200, an electric car which the user is using and uses the facility 200 or a neighboring facility.

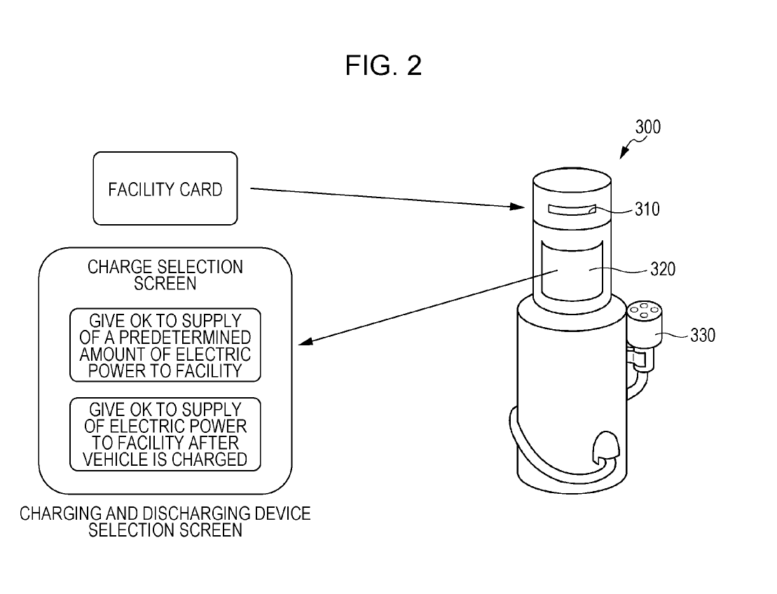

FIG. 2 is an external view of the charging and discharging device 300.

The charging and discharging device 300 is provided with a card slot 310 that receives a card inserted thereinto and reads the information thereof, a display screen 320 that displays the information, and a connector (also called a plug) 330 for being connected to the mobile unit 400. As depicted also in FIG. 1, the charging and discharging devices 300 are separately provided, one for each parking space for the mobile unit 400. Incidentally, the charging and discharging device 300 may be provided with a plurality of connectors 330, and, in that case, a configuration in which one charging and discharging device 300 is provided for a plurality of parking spaces may be adopted.

The display screen 320 is a so-called touch panel and has the function of providing information to the owner of the mobile unit 400 and the function of accepting input from the owner. The information to be displayed is notified from the electric power management device 100. Moreover, the contents of the input from the owner are transferred to the electric power management device 100.

The card slot 310 is a slot into which a loyalty card which is a card indicating the membership of the user who uses the facility 200 and is used in the facility 200, a cash card, a credit card, or the like is inserted, and the card slot 310 reads the information of the inserted card. The read information (identification information indicating the owner of the card, the number of facility use points, or the like) is transferred to the electric power management device 100, and the electric power management device 100 uses the information to add an incentive.

The connector 330 connects the charging and discharging device 300 and the mobile unit 400 and is used to transmit and receive electric power. At the time of transmission of electric power, the generated electric power is transmitted to the facility 200 from the power generator 410 of the mobile unit 400. At the time of reception of electric power, the electric power is received from an electric power system 350 and the power generator 410 of the mobile unit 400 is charged therewith. At this time, the electric power management device 100 and the charging and discharging device 300 may be connected to each other with an electric wire which is used in at least one of transmission and reception of the electric power.

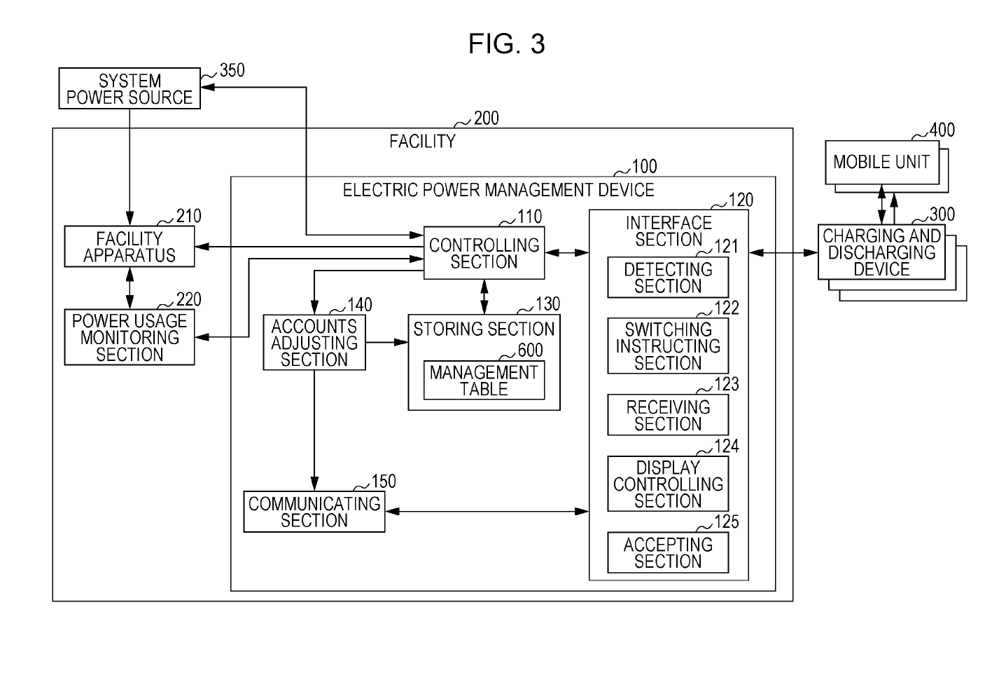

FIG. 3 is a block diagram depicting an example of the functional configuration of the electric power management device 100.

The electric power management device 100 includes a controller circuitry 110, an interface section 120, a storing section 130, an accounts adjusting section 140, and a communicator 150.

The controller circuitry 110 is provided with a processor that has the function of controlling the individual sections of the electric power management device 100 and the storing section 130 that holds a control program causing control to be performed via the processor. Some examples of the processor are an MPU and a CPU. An example of the storing section is a memory. The controller circuitry 110 may be formed of a single controller that performs centralized control or may be formed of a plurality of controllers that perform distributed control in cooperation with each other.

When receiving information on detection of connection of the mobile unit 400 from the interface section 120, the controller circuitry 110 detects whether or not information corresponding to the charging and discharging device 300 is recorded on a management table 600 of the storing section 130 and deletes the corresponding information if the information corresponding to the charging and discharging device 300 is recorded on the management table 600. Then, in the management table 600 of the storing section 130, information obtained by relating the identification information of the mobile unit 400 which is newly connected to the charging and discharging device 300 or the owner thereof to the identification information of the charging and discharging device 300 is recorded on the management table 600.

Moreover, when receiving the information on detection of connection, the controller circuitry 110 gives an interface section 120 an instruction about information of an interface screen for receiving the designation of a mode or the designation of a payment method for the charging and discharging device 300 to which the mobile unit 400 is connected.

Furthermore, the controller circuitry 110 records the information on the mode received from a receiver 123 in the management table 600 in a state in which the information is related to a portion corresponding to the identification information of the charging and discharging device 300 that has transmitted the mode information.

Moreover, the controller circuitry 110 has the function of performing control of a supply destination of the generated electric power of the power generator 410 and the stored electric power of the electricity storage device 420 of the mobile unit 400 connected to the charging and discharging device 300 and giving an instruction about the supply destination in accordance with the received mode information. In particular, the controller circuitry 110 receives the amount of electric power used which is notified from the power usage monitoring section 220 and determines whether or not the amount of electric power used is about to exceed the contract amount of electric power of the facility 200, the contract amount of electric power stored in the storing section 130. Incidentally, in other words, this determination can be called a determination as to whether or not the amount of electric power used is likely to exceed the contract amount of electric power or a prediction that the amount of electric power used will exceed the contract amount of electric power. In addition, the controller circuitry 110 has the function of giving, when the amount of electric power used is about to exceed the contract amount of electric power, an instruction to the interface section 120 such that the supply destination of the generated electric power of the power generator 410 by the electric power switching section 430 of the mobile unit 400 is set to the facility 200. Incidentally, the controller circuitry 110 determines whether or not the amount of electric power used is about to exceed the contract amount of electric power by making a determination as to whether or not the amount of electric power used is greater than or equal to a threshold value which is smaller than the contract amount of electric power. This threshold value is stored in the storing section 130. Moreover, at the time of initial connection, the electric power management device 100 gives an instruction to the electric power switching section 430 of the mobile unit 400 to set the supply destination of the generated electric power of the power generator 410 to the electricity storage device 420 in any mode.

Furthermore, when accepting a notification indicating that the connection is terminated, the controller circuitry 110 gives an instruction to the accounts adjusting section 140 to perform calculation of an incentive and addition of the incentive to a payment means of the owner of the mobile unit 400 whose connection has been terminated.

The interface section 120 is connected to each charging and discharging device 300 with or without wires and has the function of performing communication with each charging and discharging device 300 in accordance with an instruction from the controller circuitry 110.

The interface section 120 has the function of sending a control command to the charging and discharging device 300 and to the mobile unit 400 via the charging and discharging device 300 in accordance with an instruction from the controller circuitry 110 and receiving, from the charging and discharging device 300, the information on the mobile unit 400 connected to the charging and discharging device 300 and providing a notification thereof to the controller circuitry 110.

The interface section 120 includes a detector 121, a switching instructing section 122, the receiver 123, and display control circuitry 124.

When the mobile unit 400 is connected to the charging and discharging device 300, the detector 121 detects the connection of the mobile unit 400 by receiving, from the charging and discharging device 300, the information indicating that the mobile unit 400 has been connected. At this time, the detector 121 notifies the controller circuitry 110 of the connection of the mobile unit 400 in a state in which the notification is related to the identification information of the charging and discharging device 300 to which the mobile unit 400 has been connected and the mobile unit 400 (or the identification information of the owner of the mobile unit 400).

Moreover, when the mobile unit 400 is disconnected from the charging and discharging device 300, the detector 121 detects the disconnection of the mobile unit 400 by receiving, from the charging and discharging device 300, information indicating that the connection of the mobile unit 400 has been terminated. At this time, the detector 121 notifies the controller circuitry 110 of the termination of the connection of the mobile unit 400 in a state in which the notification is related to the identification information of the charging and discharging device 300 to which the mobile unit 400 was connected.

The switching instructing section 122 outputs an instruction to the electric power switching section 430 of the mobile unit 400 to switch the supply destination of the generated electric power of the power generator 410 to the mobile unit 400 connected to the charging and discharging device 300 via the charging and discharging device 300 in accordance with an instruction from the controller circuitry 110.

The receiver 123 has the function of receiving information on the mode related to charge and discharge about the mobile unit 400 connected to the charging and discharging device 300 from the charging and discharging device 300 or the communicator 150 and notifying the controller circuitry 110 of the information. As the information on the mode related to charge and discharge, there are a first mode in which the generated electric power of the power generator 410 of the mobile unit 400 is preferentially supplied to supplied to an outside of the mobile unit 400 and a second mode in which the electricity storage device 420 of the mobile unit 400 is preferentially charged with the generated electric power of the power generator 410 or the electric power from the electric power system supplied to the facility 200. Here, “An outside of the mobile unit” is a power demander of an outside of the mobile unit. The power demander, for example, are at least one of the facility 200 (more exactly, a facility apparatus 210) and the electric power system. The facility apparatus 210 is an electric apparatus provided in the facility 200.

Here, the first mode and the second mode will be described. In each mode, a first amount of stored electricity and a second amount of stored electricity which is larger than the first amount of stored electricity are set.

The first amount of stored electricity is a threshold value for the amount of stored electricity of the electricity storage device 420 in that mode and indicates the amount of electric power at which the electric power cannot be supplied to the facility 200 from the mobile unit 400 if the amount of stored electricity is smaller than the threshold value. As the first amount of stored electricity, for example, a value which is greater than or equal to the lower limit amount of stored electricity of the mobile unit 400 may be set. The lower limit amount of stored electricity refers to a lower limit of the amount of stored electricity of the electricity storage device 420 which is required by the mobile unit 400 to arrive at a destination; if the amount of stored electricity of the electricity storage device 420 of the mobile unit 400 is below this lower limit, the mobile unit 400 cannot arrive at the destination.

Since the lower limit amount of stored electricity is determined for each mobile unit 400 depending on the distance to a destination of each mobile unit 400, the lower limit amount of stored electricity differs from one mobile unit 400 to another. Here, it is assumed that the lower limit amount of stored electricity is calculated from the distance to a destination registered in a car navigation system or the like of each mobile unit 400 and the power consumption of the mobile unit 400 per unit time and is recorded on the mobile unit 400.

The second amount of stored electricity is a threshold value for the amount of stored electricity of the electricity storage device 420 in that mode and indicates the amount of electric power at which the electric power may be supplied to the facility 200 or the electric power system from the mobile unit 400 if the amount of stored electricity is greater than or equal to the threshold value.

The first amount of stored electricity and the second amount of stored electricity in the second mode are set so as to be larger than the first amount of stored electricity and the second amount of stored electricity in the first mode. As a result, by selecting the second mode, the electric power is more easily stored in the electricity storage device 420 than in the first mode. The values of the first amount of stored electricity and the second amount of stored electricity may be set depending on the ratio to the amount of electric power of the electricity storage device 420 observed when the electricity storage device 420 is fully charged or may be fixed values of the amount of electric power. In this embodiment, as an example, it is assumed that the first amount of stored electricity in the second mode is 60% of the amount of electric power of the electricity storage device 420 observed when the electricity storage device 420 is fully charged, the second amount of stored electricity in the second mode is 80% of the amount of electric power of the electricity storage device 420 observed when the electricity storage device 420 is fully charged, the first amount of stored electricity in the first mode is 50% of the amount of electric power of the electricity storage device 420 observed when the electricity storage device 420 is fully charged, and the second amount of stored electricity in the first mode is 65% of the amount of electric power of the electricity storage device 420 observed when the electricity storage device 420 is fully charged. That is, in this case, this means that, if the mode is set to the second mode, for example, when the amount of stored electricity of the electricity storage device 420 of the mobile unit 400 becomes 80% or more of the amount of electric power of the electricity storage device 420 observed when the electricity storage device 420 is fully charged, the supply to the facility 200 becomes possible; when the amount of stored electricity of the electricity storage device 420 of the mobile unit 400 becomes less than 60% of the amount of electric power of the electricity storage device 420 observed when the electricity storage device 420 is fully charged, the supply to the facility 200 becomes impossible.

The display control circuitry 124 has the function of sending the information on an interface screen to be displayed on the display screen 320 of the charging and discharging device 300 to the charging and discharging device 300 in accordance with an instruction from the controller circuitry 110. Moreover, the display control circuitry 124 also has the function of giving an instruction to the communicator 150 to send the information on the interface screen to a portable terminal of the owner of the mobile unit 400 and display the information. In the display control circuitry 124, as an interface screen, there are an interface screen that asks the owner of the mobile unit 400 which mode to apply: the second mode or the first mode, an interface screen that asks the owner of the mobile unit 400 whether he/her permits a supply of the electric power to the facility 200 from the mobile unit 400 when he/her selects the second mode, and an interface screen that asks the owner of the mobile unit 400 about a method (a payment method) of paying an incentive which is paid by the facility 200 when the electric power is supplied to the facility 200 from the mobile unit 400.

The storing section 130 is a memory that stores a program or data which is required by the electric power management device 100 to operate. The storing section 130 holds the management table 600 which is referred to by the controller circuitry 110 to control the mobile unit 400 connected to each charging and discharging device 300. The details of the management table 600 will be described later.

The accounts adjusting section 140 has the function of calculating an incentive for each mobile unit 400 in accordance with the payment method of the owner of each mobile unit 400 when there is a supply of the electric power from the mobile unit 400 in accordance with an instruction from the controller circuitry 110 and adding the incentive to the payment means.

The communicator 150 has the function of performing communication with an external apparatus wirelessly or with wires. Here, in particular, the communicator 150 has the function of performing communication with a portable terminal, such as a smartphone, of the owner of the mobile unit 400 or, when money is used in incentive payment, a communication function of paying money into an account of the owner of the mobile unit 400. Moreover, when a point is used in incentive payment, the communicator 150 may have a communication function of adding a point to a point management system of the owner of the mobile unit 400. Incidentally, although the point management system is not depicted in the drawing, the point management system holds, for each owner, the information to which the accumulated and unused points are related.

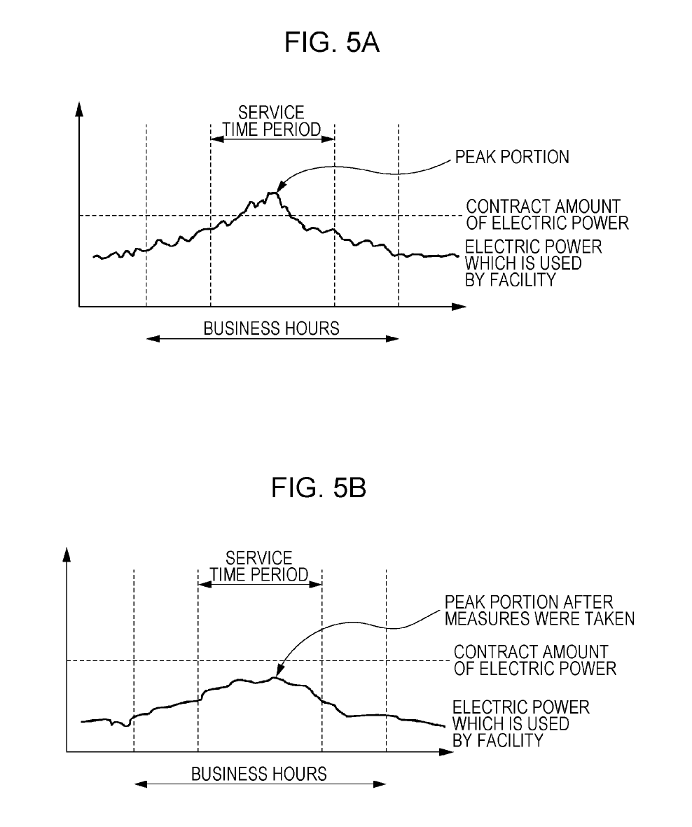

Peak shaving of the electric power by the controller circuitry 110 of the electric power management device 100 will be described by using FIGS. 5A and 5B.

FIGS. 5A and 5B are each an image diagram about peak shaving of the electric power by electric power leveling; FIG. 5A is a graph depicting the transition of the amount of electric power used before electric power leveling and FIG. 5B is a graph depicting the transition of the amount of electric power used after electric power leveling.

It is assumed that the transition of the amount of electric power which is used by the facility 200 is the transition depicted in FIG. 5A. When the facility 200 is supplied with the electric power from the electric power system by a high-voltage block power-receiving method, the peak usage of the annual or monthly amount of electric power used affects the next year's or next month's electric power charge. Therefore, it is preferable to prevent the occurrence of a peak (FIG. 5A, a peak portion) as a result of the amount of electric power used exceeding the contract amount of electric power as depicted in FIG. 5A.

Thus, in the electric power management system according to Embodiment 1, the electric power management device 100 supplies the generated electric power generated by the power generator 410 of the mobile unit 400 to the facility 200, whereby, as depicted in FIG. 5B, it is possible to reduce a possibility that the peak electric power exceeds the contract amount of electric power.

Incidentally, a contract electric power threshold value is set to a value which is smaller than the contract amount of electric power depicted in FIGS. 5A and 5B.

FIG. 4 is a block diagram depicting an example of the functional configuration of the mobile unit 400.

As depicted in FIG. 4, the mobile unit 400 includes the power generator 410, the electricity storage device 420, the electric power switching section 430, and a connection terminal 440.

The power generator 410 has the function of generating electric power and outputting the generated electric power to the electric power switching section 430. Any power generator 410 can be adopted as long as the power generator 410 can generate electric power, and the power generator 410 may be a photovoltaic power generating system or a fuel cell using hydrogen, biomass, or the like. Incidentally, when the power generator 410 is a fuel cell, the power generator 410 may generate electric power by using fuel from a fuel container of the mobile unit 400 or generate electric power by using fuel which is supplied from the facility 200. Here, the fuel is hydrogen-containing gas.

The electricity storage device 420 is a so-called battery having the function of storing, in a battery cell (not depicted in the drawing), the electric power which is supplied from the power generator 410 via the electric power switching section 430 and performing discharge in accordance with an instruction from the electric power switching section 430.

The electric power switching section 430 has the function of switching between a supply of the electric power generated by the power generator 410 to the electricity storage device 420 and a supply of the electric power to the facility 200. Moreover, the electric power switching section 430 also has the function of supplying the electric power supplied from the electric power system to the electricity storage device 420 and charging the electricity storage device 420. At this time, the electric power from the electric power system may be supplied to the electricity storage device 420 via a first power feeding section (not depicted in the drawing) of the electric power management device 100. Furthermore, an detector (not depicted in the drawing) provided in the mobile unit 400 detects the amount of stored electricity of the electricity storage device 420 and the detected amount of stored electricity is transferred one after another to the charging and discharging device 300 to which the mobile unit 400 is connected via the connection terminal 440. The detected amount of stored electricity is transferred to the electric power management device 100 via the receiver 123. Here, the receiver 123 is an example of a first acquirer of the present disclosure.

The connection terminal 440 connects to the connector 330 of the charging and discharging device 300 or a connection terminal of a house and exchanges electric power therewith. The connection terminal 440 is an example of a second power feeding section of the present disclosure.

### <Data>

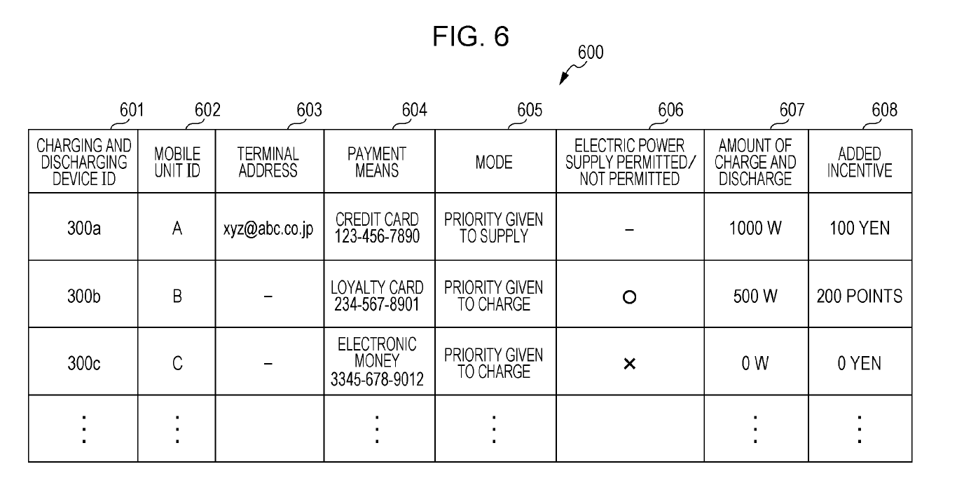

FIG. 6 is a conceptual diagram depicting the data configuration of the management table 600.

As depicted in FIG. 6, the management table 600 is information to which a charging and discharging device ID 601 of the charging and discharging device 300, a mobile unit ID 602 of the mobile unit 400 connected to the charging and discharging device 300, a terminal address 603 of an owner when the owner is registered as the owner of the mobile unit 400, a payment means 604, a mode 605, electric power supply permitted/not permitted 606, an amount of charge and discharge 607, and an added incentive 608 are related.

The charging and discharging device ID 601 is identification information used by the electric power management device 100 to recognize and differentiate each charging and discharging device 300.

The mobile unit ID 602 is identification information used by the electric power management device 100 to recognize and differentiate the mobile unit 400 connected to the charging and discharging device 300.

The payment means 604 is information indicating the type of an incentive which is granted to the owner of the mobile unit 400, and examples thereof include a credit card or a facility card (a loyalty card) which is used when the owner uses the facility 200. In the case of the credit card, it is possible to grant money directly as an incentive; in the case of the loyalty card, it is possible to grant, as an incentive, a point for giving a discount on a facility usage fee in accordance with the accumulated points or exchanging the accumulated points for a gift.

The mode 605 is information indicating whether the mode is set to the second mode or the first mode.

The electric power supply permitted/not permitted 606 is information indicating whether a supply of the electric power is permitted or not even when the mode is set to the second mode.

The amount of charge and discharge 607 is information indicating the amount of charge which the mobile unit 400 has received from the facility 200 and the amount of electric power corresponding to the generated electric power of the power generator 410 of the mobile unit 400 or the stored electric power of the electricity storage device 420, the generated electric power or the stored electric power supplied to the facility 200.

The added incentive 608 is information indicating the value of an incentive which is added to the payment means of the owner of the corresponding mobile unit 400.

As a result of the storing section 130 holding this management table 600, the electric power management device 100 can perform charge and discharge control, calculation of an incentive, and so forth on each mobile unit 400 connected thereto. As for the information in each line of the management table 600, every time the mobile unit 400 is connected to the charging and discharging device 300, the information on that charging and discharging device 300 is reset and newly recorded.

### <Operation>

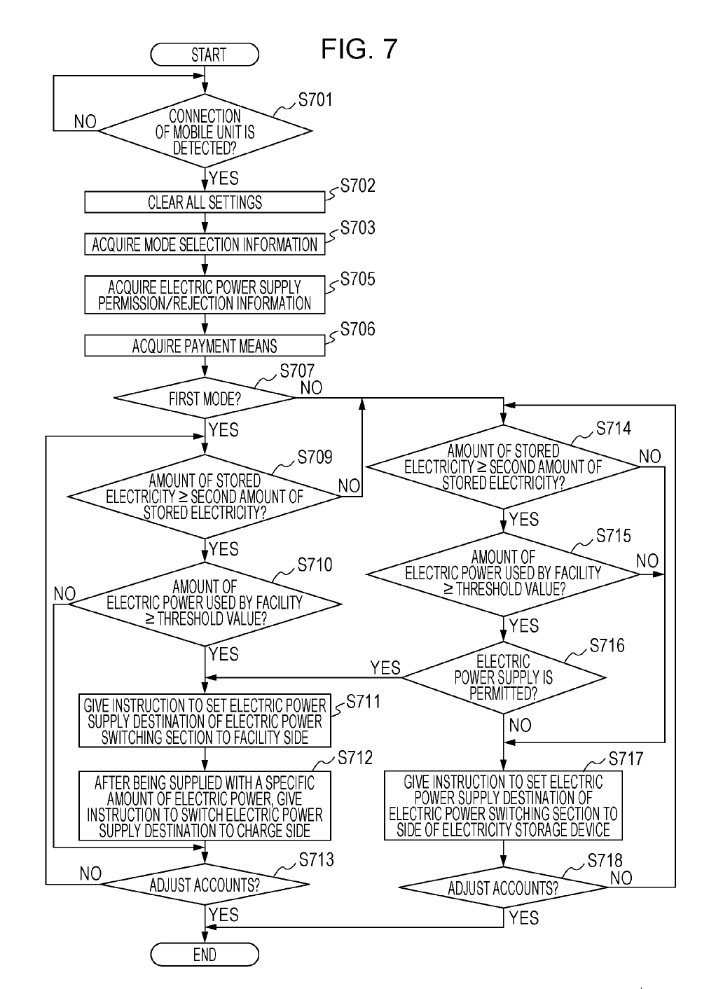

FIG. 7 is a flowchart depicting the operation of the electric power management device 100. The processing depicted in FIG. 7 is a flowchart depicting the operation of the electric power management device 100 which is performed on one charging and discharging device 300.

The processing depicted in FIG. 7 is the operation of the electric power management device 100 which is performed from when the mobile unit 400 is connected to one charging and discharging device 300 till when the connection is terminated.

When the mobile unit 400 is connected to the connector 330, the charging and discharging device 300 sends, to the detector 121 of the electric power management device 100, information indicating that the mobile unit 400 has been connected.

If the electric power management device 100 is notified of the connection of the mobile unit 400 from the charging and discharging device 300 (YES in step S701), the electric power management device 100 clears all the setting information of the management table 600 corresponding to the charging and discharging device 300 (step S702).

The electric power management device 100 acquires mode selection information via the receiver 123 (step S703).

The mode selection information is information indicating whether the owner of the mobile unit 400 has selected the second mode or the first mode. The controller circuitry 110 of the electric power management device 100 gives an instruction to the interface section 120 to display the interface screen that requests mode selection.

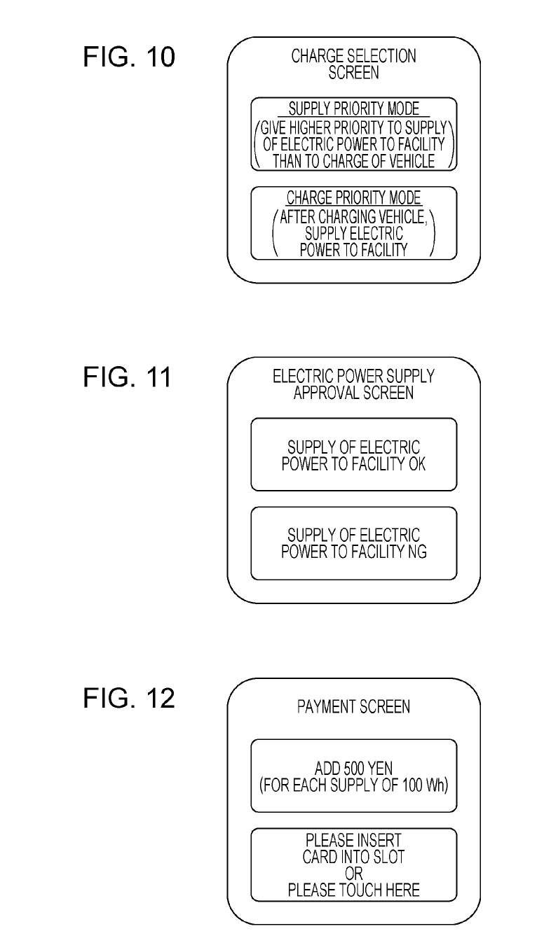

When the interface section 120 accepts this instruction, the display control circuitry 124 sends, to the charging and discharging device 300, an instruction to display an interface screen related to the mode selection, and the charging and discharging device 300 displays, on the display screen 320, the interface screen about which the instruction was given thereto (see FIG. 10).

In response to the interface screen displayed on the display screen 320, the owner of the mobile unit 400 performs input to select the mode. The charging and discharging device 300 sends the mode selection information in accordance with the input contents to the electric power management device 100.

When receiving the mode selection information, the receiver 123 of the interface section 120 of the electric power management device 100 transfers the mode selection information to the controller circuitry 110. The controller circuitry 110 stores the mode selection information in a state in which the mode selection information is related to the charging and discharging device 300 in the management table 600 in accordance with the contents of the mode selection information indicating whether the mode is the second mode or the first mode. Incidentally, in step S703 described above, the receiver 123 is an example of a first receiver of the present disclosure.

The receiver 123 of the electric power management device 100 acquires electric power supply permission/rejection information (step S705). The controller circuitry 110 makes the display control circuitry 124 make the display screen 320 of the charging and discharging device 300 display an interface screen (see FIG. 11) asking the owner of the mobile unit 400 whether he/her permits a supply of the electric power from the mobile unit 400 when the second mode is selected. Then, in accordance with the input performed by the owner on this screen, the controller circuitry 110 acquires the permission/rejection information via the receiver 123 and records the permission/rejection information in the management table 600. The electric power supply permission/rejection information is information indicating whether or not the owner of the mobile unit 400 permits a supply of the electric power from the mobile unit 400 when the second mode is selected in step S703 and the facility 200 needs the electric power. Incidentally, the processing in step S705 is omitted if the owner of the mobile unit 400 has selected the first mode in step S703. Incidentally, in step S705 described above, the receiver 123 is an example of a second receiver of the present disclosure. Incidentally, in this example, the receiver 123 functions all of the first receiver, the second receiver and the first acquirer of the present disclosure, but the configuration is not limited thereto. That is, the first receiver, the second receiver and the first acquirer may be provided separately. Moreover, step S705 described above is performed in advance before it is determined in step S715 that the amount of electric power used by the facility 200 is greater than or equal to a threshold value which is smaller than the contract amount of electric power of the facility 200. However, the example is not limited thereto; step S705 described above may be performed after it is determined in step S715 described above that the amount of electric power used by the facility 200 is greater than or equal to a threshold value which is smaller than the contract amount of electric power of the facility 200.

Next, the electric power management device 100 accepts the payment method designated by the owner of the mobile unit 400 via the accepting section 125 (step S706). Specifically, the electric power management device 100 gives an instruction to the charging and discharging device 300 to display an interface screen asking about the payment method on the display screen 320 via the display control circuitry 124 of the interface section 120 (see FIG. 12).

In response to this, the owner of the mobile unit 400 selects the payment method in accordance with the contents of the interface screen thus displayed. When receiving the input of this selection, the charging and discharging device 300 sends the information thereon to the electric power management device 100.

When receiving this information, the interface section 120 transfers the information to the controller circuitry 110, and the controller circuitry 110 records the information in a corresponding portion of the management table 600.

Incidentally, the processing in step S706 is omitted if the owner of the mobile unit 400 selects the second mode and rejects an electric power supply.

Moreover, acceptance of the designation of the payment method may be performed by reading the information of the card inserted into the card slot 310 of the charging and discharging device 300.

The electric power management device 100 determines whether or not the mobile unit 400 corresponding to the charging and discharging device 300 is in the first mode by referring to the management table 600 (step S707).

If the first mode is set for the electric power control of the mobile unit 400 (YES in step S707), the controller circuitry 110 compares the amount of stored electricity and the second amount of stored electricity (step S709). Here, the second amount of stored electricity is the second amount of stored electricity which is set for the first mode and is the amount of stored electricity of the electricity storage device 420 with which it is determined that the electric power can be supplied to the outside (for example, the facility 200) from the mobile unit 400 as described above.

If the amount of stored electricity is larger than or equal to the second amount of stored electricity (YES in step S709), the controller circuitry 110 acquires the amount of electric power used by the facility which is measured by the power usage monitoring section 220. Then, the controller circuitry 110 compares the acquired amount of electric power used by the facility with a threshold value which is smaller than the contract amount of electric power of the facility 200 (step S710). If the amount of electric power used by the facility is smaller than the above-described threshold value, the procedure proceeds to step S713.

If the amount of electric power used by the facility is greater than or equal to the above-described threshold value (YES in step S710), the controller circuitry 110 gives an instruction to the interface section 120 to send an instruction by which the electric power supply destination of the electric power switching section 430 of the mobile unit 400 is set to the facility 200 (step S711). The interface section 120 sends this instruction to the charging and discharging device 300, and the charging and discharging device 300 sends, to the electric power switching section 430 of the mobile unit 400 connected thereto, an instruction by which the electric power supply destination is set to the facility 200. When receiving this instruction, the electric power switching section 430 of the mobile unit 400 sets the supply destination of the electric power to the facility 200 (the charging and discharging device 300).

After being supplied with a specific amount of electric power from the mobile unit 400, the controller circuitry 110 gives, via the interface section 120 and the charging and discharging device 300, an instruction to the electric power switching section 430 of the mobile unit 400 to switch the supply destination of the electric power from the facility 200 to the electricity storage device 420 (step S712).

The controller circuitry 110 detects input of payment from the owner of the mobile unit 400 or the termination of the connection of the mobile unit 400 to the charging and discharging device 300 by receiving a payment request or connection termination information from the charging and discharging device 300 (step S713).

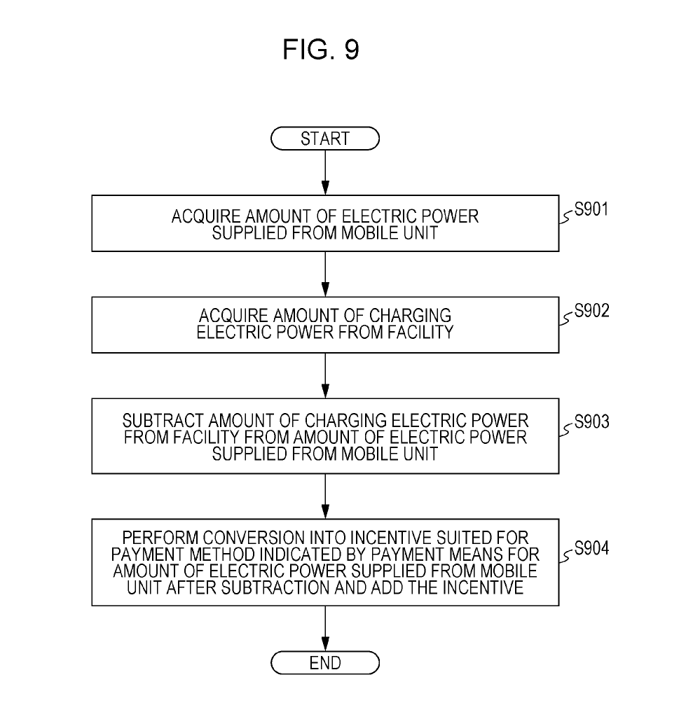

If the payment request or the connection termination information has been received (YES in step S713), the procedure proceeds to payment processing depicted in FIG. 9. If the payment request or the connection termination information has not been received (NO in step S713), the procedure goes back to step S708.

On the other hand, if the selected mode is the second mode (NO in step S707), the controller circuitry 110 determines whether or not the amount of stored electricity is larger than or equal to the second amount of stored electricity (step S714).

If the amount of stored electricity is larger than or equal to the second amount of stored electricity (YES in step S714), the controller circuitry 110 determines whether or not the amount of electric power used by the facility is greater than or equal to a threshold value which is smaller than the contract amount of electric power (step S715). If the amount of stored electricity is not larger than or equal to the second amount of stored electricity, the procedure proceeds to step S717. Here, the second amount of stored electricity is the second amount of stored electricity which is set for the second mode and is the amount of stored electricity of the electricity storage device 420 with which it is determined that the electric power can be supplied to the outside (for example, the facility 200) from the mobile unit 400 as described above.

If the amount of electric power used by the facility is greater than or equal to the threshold value (YES in step S715), the controller circuitry 110 determines whether or not the electric power supply is permitted by referring to the management table 600 (step S716). If the amount of electric power used by the facility is not greater than or equal to the threshold value (NO in step S715), the procedure proceeds to step S717.

If the electric power supply is permitted (YES in step S716), the procedure proceeds to step S711 and the subsequent processing is performed. That is, if the electric power supply is permitted, the controller circuitry 110 gives an instruction to the electric power switching section 430 of the mobile unit 400 to set the supply destination of the electric power to the facility 200 via the interface section 120 and the charging and discharging device 300.

If the electric power supply is not permitted (NO in step S716), the controller circuitry 110 gives an instruction to the electric power switching section 430 of the mobile unit 400 to set the supply destination of the generated electric power of the power generator 410 to the electricity storage device 420 via the interface section 120 and the charging and discharging device 300 (step S717). As a result, the electricity storage device 420 is charged with the electric power generated by the power generator 410.

The controller circuitry 110 detects input of payment from the owner of the mobile unit 400 or the termination of the connection of the mobile unit 400 to the charging and discharging device 300 by receiving a payment request or connection termination information from the charging and discharging device 300 (step S718).

If the payment request or the connection termination information has been received (YES in step S718), the procedure proceeds to payment processing depicted in FIG. 9. If the payment request or the connection termination information has not been received (NO in step S718), the procedure goes back to step S714.

Incidentally, in FIG. 7, steps S703 to S706 form processing for acquiring initial information to control the mobile unit 400, and step S707 and the subsequent steps form actual control processing.

By performing the processing depicted in FIG. 7, the electric power management device 100 can supply the generated electric power of the power generator 410 of the mobile unit 400 or the stored electric power of the electricity storage device 420 to the facility apparatus 210 of the facility 200. This makes it possible to suppress the peak amount of electric power in the facility 200.

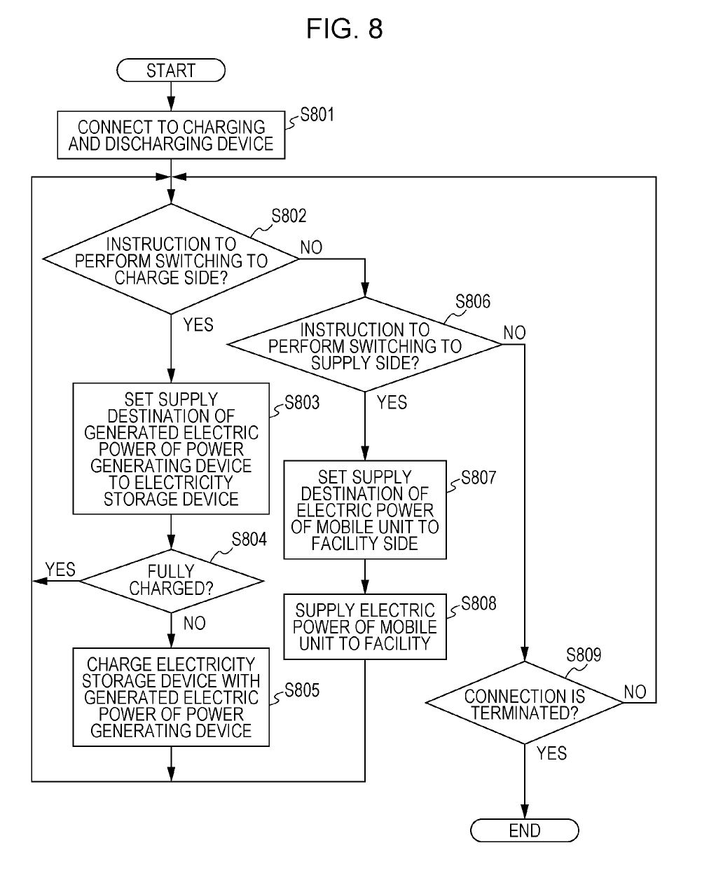

FIG. 8 is a flowchart depicting the operation of the mobile unit 400.

The processing depicted in FIG. 8 depicts the operation of the mobile unit 400 which is performed from when the mobile unit 400 is connected to the charging and discharging device 300 till when the connection is terminated.

First, the mobile unit 400 is connected to the charging and discharging device 300 via the connector 330 (step S801). The connector 330 is connected to a receptacle therefor by the owner of the mobile unit 400.

Then, the processing depicted in FIG. 7 is performed, whereby the mode, the payment method, and so forth are set in the electric power management device 100 by the owner of the mobile unit 400 via the charging and discharging device 300 to which the mobile unit 400 is connected or the portable terminal of the owner.

Then, the mobile unit 400 waits for an instruction from the electric power management device 100. Incidentally, although the details are not described to avoid verbosity in the description of FIG. 8, the instruction from the electric power management device 100 is transferred via the charging and discharging device 300 by way of the connector 330 to which the mobile unit 400 is connected.

If the instruction from the electric power management device 100 is an instruction to the electric power switching section 430 to perform switching to the electric storage side (YES in step S802), the supply destination of the generated electric power of the power generator 410 is set to the electricity storage device 420 (step S803).

An electric power generation controller circuitry 431 of the electric power switching section 430 detects whether or not the battery cell of the electricity storage device 420 is fully charged (step S804).

If the battery cell of the electricity storage device 420 is fully charged (YES in step S804), the procedure goes back to step S802.

If the battery cell of the electricity storage device 420 is not fully charged (NO in step S804), the electric power generation controller circuitry 431 gives an instruction to the power generator 410 to generate electric power, the battery cell of the electricity storage device 420 is charged with the generated electric power generated by the power generator 410 by way of the electric power switching section 430 (step S805), and the procedure goes back to step S802. The electric power generation controller circuitry 431 is an example of a charging section of the present disclosure.

If the instruction from the electric power management device 100 is not an instruction to the electric power switching section 430 to perform switching to charge the electricity storage device 420, but an instruction to perform switching to supply the electric power to the outside of the mobile unit 400 from the electricity storage device 420 (NO in step S802, YES in step S806), the electric power switching section 430 switches the supply destination of the electric power of the mobile unit 400 (the generated electric power of the power generator 410 or the stored electric power of the electricity storage device 420) to the facility 200 (step S807).

Then, the electric power is supplied to the electric power management device 100 via the charging and discharging device 300 (step S808). The electric power is supplied mainly to the facility apparatus 210 from the electric power management device 100.

If the connection of the mobile unit 400 to the charging and discharging device 300 is terminated (YES in step S809), the processing is ended; if the connection of the mobile unit 400 to the charging and discharging device 300 is not terminated (NO in step S809), the procedure goes back to step S802.

As depicted in FIG. 8, the mobile unit 400 supplies the generated electric power of the power generator 410 thereof directly to the facility 200 in accordance with the instruction from the electric power management device 100.

FIG. 9 is a flowchart depicting an operation related to incentive calculation which is performed by the electric power management device 100 and depicts processing which is performed after the processing of FIG. 7.

When the connection of the mobile unit 400 to the charging and discharging device 300 is terminated, the accounts adjusting section 140 of the electric power management device 100 reads the amount of electric power which the mobile unit 400 has supplied to the facility 200 from the management table 600 of the storing section 130 (step S901).

Next, the accounts adjusting section 140 reads the amount of electric power which the mobile unit 400 has received from the facility 200 from the management table 600 of the storing section 130 (step S902).

The accounts adjusting section 140 subtracts the amount of stored electric power obtained in step S902 from the amount of supplied electric power obtained in step S901 (step S903).

Then, the accounts adjusting section 140 pays an incentive for the amount of electric power obtained in step S903 (step S904). If a paying device is credit, the accounts adjusting section 140 performs, via the communicator 150, processing to pay the calculated incentive to the account of the owner of the mobile unit 400. If the paying device is a point, the accounts adjusting section 140 gives an instruction to the charging and discharging device 300 to add a point to the facility card of the owner of the mobile unit 400. The charging and discharging device 300 performs processing to add, to the facility card inserted into the card slot 310, the point about which the instruction has been given. For example, an incentive of 50 yen/kW in the case of cash or an incentive of 200 points/kW in the case of a point is added to the account or the facility card of the owner of the mobile unit 400. At this time, if the amount of electric power obtained by subtraction is 0 or less, the accounts adjusting section 140 does not pay an incentive. Incidentally, the accounts adjusting section 140 is an example of a paying section of the present disclosure.

The accounts adjusting section 140 performs the incentive payment processing in this manner and ends the incentive payment processing. When a supply of the electric power is received, by paying an incentive to the owner of the mobile unit 400 which has supplied the electric power, it is possible to expect an improvement in the facility utilization rate of the owner.

### <Modified Examples of Incentive Payment>

The following is explanations of modified examples of a method of paying an incentive in this embodiment.

### <Incentive Payment Example 1>

The facility 200 desires the owner of the mobile unit 400 to use the facility 200. Therefore, the facility 200 desires to perform incentive payment which makes the owner feel like using the facility 200.

Thus, the registration of a portable terminal which has been voluntarily made in the above-described embodiment is made mandatory. Here, it is assumed that the portable terminal has the function, such as the GPS function, which makes it possible for the portable terminal to output the positional information thereof.

Then, a second acquiring section (not depicted in the drawing) provided in the electric power management device 100 acquires the positional information of a terminal which is registered in the management table 600 one after another (every 5 minutes, for example). As a result, the electric power management device 100 can grasp the position of the owner of the mobile unit 400. In the storing section 130, the site range of the facility 200 is held in advance as longitude and latitude information. Then, when the electric power is supplied to the facility 200 from the mobile unit 400, it is checked whether or not the acquired terminal positional information is present in the site range of the facility 200, and, if the acquired terminal positional information is present in the site range, an incentive is paid as normal; if the acquired terminal positional information is not present in the site range, an incentive is not paid for the electric power supply at that time. Incidentally, this incentive payment is not limited to the example described above, and the incentive payment may exist in any form as long as the amount of incentive payment which is performed when the positional information of the terminal is present in the site range is larger than the amount of incentive payment which is performed when the positional information of the terminal is present outside the site range. For example, an incentive of 50 yen/kW or an incentive of 200 points/kW may be paid to the owner if the owner is present in the site range of the facility 200, and an incentive of 10 yen/kW or an incentive of 50 points/kW may be paid to the owner if the owner is present outside the site range of the facility 200.

### <Incentive Payment Example 2>

In the above-described embodiment, payment of an incentive is calculated depending only on the amount of charge and discharge.

However, the facility 200 sometimes desires to pay a larger amount of incentive payment to an owner of a mobile unit 400 that has supplied the electric power in order to show their deeper gratitude to the owner. For example, a configuration may be adopted in which a larger amount of incentive is paid if the electric power is supplied from the mobile unit 400 when the amount of electric power used in the facility 200 increases rapidly and the amount of electric power used is about to exceed the contract amount of electric power, that is, the facility 200 desires to be supplied with the electric power more quickly.

That is, in the above-described embodiment, only one threshold value is provided for the amount of electric power used, but a configuration may be adopted in which a plurality of threshold values are provided and the amount of payment of an incentive is changed in accordance with a threshold value of the threshold values, the amount of electric power used being greater than or equal to the threshold value.

For example, a first threshold value, a second threshold value which is greater than the first threshold value, and a third threshold value which is greater than the second threshold value are provided for the amount of electric power used. Then, incentive calculation may be performed by making settings such that an incentive which is paid if the mobile unit 400 supplies the electric power when the amount of electric power used is greater than or equal to the first threshold value but smaller than the second threshold value is 50 yen/kW, an incentive which is paid if the mobile unit 400 supplies the electric power when the amount of electric power used is greater than or equal to the second threshold value but smaller than the third threshold value is 100 yen/kW, and an incentive which is paid if the mobile unit 400 supplies the electric power when the amount of electric power used is greater than or equal to the third threshold value is 150 yen/kW.

That is, a larger amount of compensation may be paid to the owner of the mobile unit 400 which contributes to a supply of the electric power when there is a more urgent need for a supply of the electric power.

### <Incentive Payment Example 3>

In the above-described embodiment, there is no difference between the second mode and the first mode in incentive payment.

However, the facility 200 desires the owner of the mobile unit 400 to select the first mode actively because it is possible to reduce the possibility that the amount of electric power used exceeds the contract amount of electric power by making it possible to be supplied with the electric power from the mobile unit 400 more actively.

Thus, settings may be made such that a larger amount of incentive is paid when a supply of the electric power is received from the mobile unit 400 that has selected the first mode than an amount of incentive which is paid when a supply of the electric power is received from the mobile unit 400 that has selected the second mode. That is, when an incentive which is paid in the second mode is set to 40 yen/kW, an incentive which is paid in the first mode may be set to 50 yen/kW.

### <Incentive Payment Example 4>

In the above-described embodiment, the configuration is adopted in which an incentive is paid only by an amount corresponding to the amount of electric power which is obtained by subtracting the amount of stored electricity obtained in step S902 from the amount of supplied electric power obtained in step S901.

However, the configuration is not limited thereto, and an incentive may be paid in the following manner.

That is, a configuration may be adopted in which a smaller amount of incentive is paid for a supply from the amount of stored electricity obtained in step S902 and a larger amount of incentive is paid for a difference obtained in step S903.

For example, a configuration may be adopted in which an incentive of 10 yen/kW or 50 points/kW is paid for the amount of supplied electric power obtained in step S901 before the amount of supplied electric power reaches the amount of stored electric power obtained in step S902 and an incentive of 50 yen/kW or 200 points/kW is paid for the amount of supplied electric power exceeding the amount of stored electric power obtained in step S902.

That is, assume that the amount of supplied electric power is A kW and the amount of stored electric power is B kW. Then, in this case, an incentive of B×10+(A−B)×50 yen is paid if payment is made by money.

### MODIFIED EXAMPLES

While the electric power management device 100 according to the present disclosure has been described in accordance with the above-described embodiment, the present disclosure is not limited thereto. Hereinafter, various modified examples included in the idea of the present disclosure will be described.

(1) In the above-described embodiment, if the amount of electric power which is used in the facility 200 is about to exceed the contract amount of electric power, the generated electric power of the power generator 410 or the electric power of the electricity storage device 420 of each mobile unit 400 is supplied to the facility apparatus 210 as it is, whereby the amount of electric power received by the facility apparatus 210 from the electric power system is reduced and the peak electric power is suppressed.

However, instead of supplying the generated electric power of the power generator 410 and the electric power of the electricity storage device 420 of the mobile unit 400 to the facility apparatus 210, the peak electric power may be suppressed by selling the generated electric power of the power generator 410 and the electric power of the electricity storage device 420 of the mobile unit 400 to an electric power system. That is, the electric power which is used by the facility apparatus 210 is supplied from the electric power system and, by making up for an amount exceeding the contract amount of electric power by selling the generated electric power of the power generator 410 and the electric power of the electricity storage device 420 of the mobile unit 400 to the electric power system, whereby apparent peak electric power may be suppressed.

(2) In the above-described embodiment, the generated electric power of the power generator 410 and the electric power of the electricity storage device 420 of the mobile unit 400 are supplied only when the amount of electric power which is used in the facility 200 is about to exceed the contract amount of electric power. However, the example is not limited thereto, and, for example, even when the amount of electric power used by the facility 200 is not about to exceed the contract amount of electric power, the generated electric power of the power generator 410 of the mobile unit 400 may be supplied to the facility 200 or sold to the electric power system when the electricity storage device 420 is fully charged. Moreover, when the owner of the mobile unit 400 selects the second mode, irrespective of whether a supply of the electric power from the mobile unit 400 is permitted or not by the owner of the mobile unit 400, when the amount of stored electricity of the electricity storage device 420 is larger than or equal to the second amount of stored electricity, the generated electric power of the power generator 410 of the mobile unit 400 may be supplied to the facility 200 or sold to the electric power system.

(3) In the above-described embodiment, the power usage monitoring section 220 is provided in the facility 200 in order to monitor the amount of electric power used by the facility apparatus 210, but the power usage monitoring section 220 may be provided in the electric power management device 100. Moreover, the electric power management device 100 may be configured as an electric power management device including the charging and discharging device 300.

(4) In the above-described embodiment, the first amount of stored electricity and the second amount of stored electricity are automatically set in accordance with the selected mode. However, the first amount of stored electricity and the second amount of stored electricity may be designated by the user instead of being automatically set.

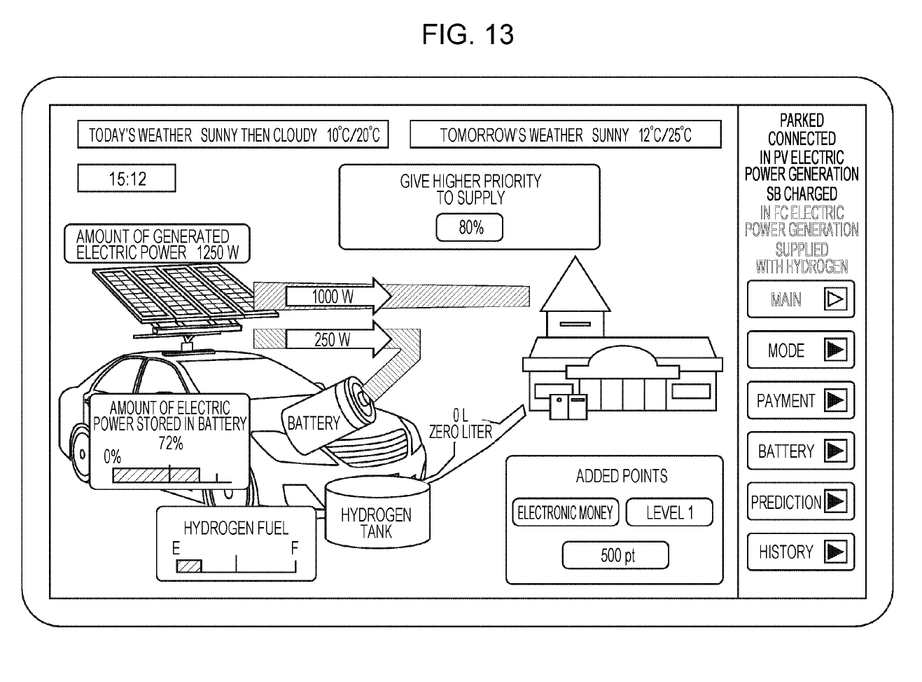

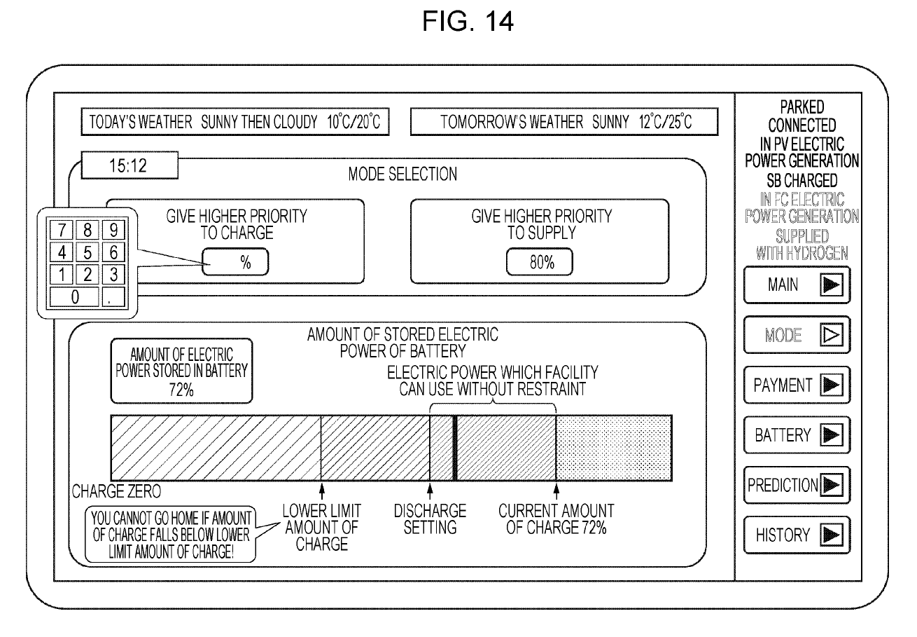

For example, the first amount of stored electricity or the second amount of stored electricity may be determined by displaying an interface screen depicted in FIG. 13 or 14 to input the numeric value thereof or specify one point in a bar indicating the amount of stored electricity.

(5) In the above-described embodiment, the mode is determined by selecting a charge selection screen which is displayed on the display screen 320. However, in place of making a mere selection, the ratio between priority given to charge and priority given to supply may be input.

For example, a configuration may be adopted in which an interface screen depicted in FIG. 14 is displayed, and, by inputting a numeric value or a designating one point in a bar indicating the amount of stored electricity, the mode is set to the first mode if the ratio of the priority given to supply is higher than the other and the mode is set to the second mode if the ratio of the priority given to charge is higher than the other.

Moreover, at this time, the second amount of stored electricity or the first amount of stored electricity of the selected mode may be changed from the initial value thereof depending on the input numeric value. For example, when supply 60% and charge 50% are input, the first mode is selected, but this input indicates an intention of the owner of the mobile unit 400 to perform charge as much as possible while having an intention to perform a supply. In such a case, the first amount of stored electricity may be changed in such a way that the first amount of stored electricity is set to a higher amount than usual. Incidentally, it is assumed that a change in this case is calculated by a previously set algorithm. At this time, it is preferable that the first amount of stored electricity or the second amount of stored electricity is calculated with an input percentage being associated therewith.

(6) In the above-described embodiment, the mobile unit 400 enters a standby state when the first mode is selected and the amount of stored electricity of the electricity storage device 420 is sufficient. During this standby state, the electric power generation controller circuitry 431 of the mobile unit 400 may make the power generator 410 generate electric power and allow the electricity storage device 420 to be charged with the generated electric power.

(7) In the above-described embodiment, FIG. 7 depicts the operation of the electric power management device 100 which is performed when one mobile unit 400 is controlled. Therefore, when the amount of electric power used in the facility 200 is about to exceed the contract amount of electric power, an electric power supply is received from all the mobile units 400 that permit a supply and have a sufficient amount of stored electricity.

However, if the amount of electric power used is within the contract amount of electric power, the electric power does not need to be supplied from all the mobile units 400 that permit a supply. Thus, when an electric power supply is received, processing to select a mobile unit 400 from which the electric power is supplied may be performed in step S711 before a switching instruction is given. Then, a switching instruction may be output only to the selected mobile unit 400.

Here, although the controller circuitry 110 may select a mobile unit 400 randomly, it is efficient to select a mobile unit 400 from which the electric power is supplied in accordance with the following criteria.

(A) The amount of stored electricity of the electricity storage device 420 in each mobile unit 400 is acquired by a receiver 123 of the electric power management device 100, and top multiple mobile units 400 of the mobile units 400, each being provided with the electricity storage device 420 whose amount of stored electricity is large, are selected. The number of these multiple mobile units 400 may be a previously set fixed number or a number which is determined based on a predetermined ratio to the total number of mobile units 400 parking in the parking lot of the facility 200. That is, the electric power is supplied to the facility 200 from the mobile unit 400 in such a way that the electric power is supplied from the mobile unit 400 with the electricity storage device 420 having a larger amount of stored electricity before the mobile unit 400 with the electricity storage device 420 having a smaller amount of stored electricity. The receiver 123 is an example of the first acquirer of the present disclosure.

(B) The amount of stored electricity of the electricity storage device 420 in each mobile unit 400 is acquired from the receiver 123 of the electric power management device 100, and top multiple mobile units 400 of the mobile units 400 in which a difference between the amount of stored electricity and the first amount of stored electricity is large are selected. The number of these multiple mobile units 400 may be a previously set fixed number or a number which is determined based on a predetermined ratio to the total number of mobile units 400 parking in the parking lot of the facility 200. That is, the electric power is supplied to the facility 200 from the mobile unit 400 in such a way that the electric power is supplied from the mobile unit 400 with the electricity storage device 420 having a larger amount of stored electricity before the mobile unit 400 with the electricity storage device 420 having a smaller amount of stored electricity. The receiver 123 is an example of the first acquirer of the present disclosure.

(C) A mobile unit 400 that sets the mode to the first mode, not a mobile unit 400 that sets the mode to the second mode, is selected.

(D) A mobile unit 400 of an owner who is not using the facility 200 is preferentially selected. The owner who is not using the facility 200 is identified by using the GPS function of the terminal of the owner in a manner similar to the method described in the incentive payment example 1 of the above-described embodiment. If the incentive payment example 1 described above is used, this selection method is particularly effective for the facility 200.

(E) If a system in which a charge or a point of incentive payment can be designated by the owner of the mobile unit 400 is adopted, a mobile unit 400 is selected from among the mobile units 400 of the owners who request a lower charge or point.

(F) If there is a mobile unit 400 whose electricity storage device 420 is charged by the electric power management device 100 via the charging and discharging device 300 by using the electric power of the electric power system, this mobile unit 400 is selected. At this time, a configuration may be adopted in which information on the amount of stored electricity from each electric power system is held for each charged mobile unit 400 and a supply is received until the amount reaches the amount of stored electricity.

As described above, a mobile unit 400 which is made to perform an electric power supply may be appropriately selected.

(8) In the above-described embodiment, the electric power management device 100 is provided in the facility 200, but the electric power management device 100 may be provided in a place other than the facility 200 as long as it is possible to monitor the amount of electric power used by each facility apparatus 210 of the facility 200 and supply the electric power received from the mobile unit 400 thereto and control each charging and discharging device 300.

(9) In the above-described embodiment, the mobile unit 400 (for example, the car navigation system incorporated into the mobile unit 400 or the RAM of the processor of the mobile unit 400) stores the lower limit amount of stored electricity, but the electric power management device 100 may calculate the lower limit amount of stored electricity. In this case, the electric power management device 100 simply has to obtain the destination information of the mobile unit 400 connected thereto and the information on the power consumption of the mobile unit 400 per unit time from the owner of the mobile unit 400 or the mobile unit 400.

(10) In FIG. 7 of the above-described embodiment, the acquisition of each information in steps S703 to S706 may not be performed in this order and may be performed in any order.

(11) A plurality of methods of the incentive payment method described in the above-described embodiment and the incentive payment methods described in the modified examples thereof may be combined and used. At this time, if a conflict between the condition of one incentive payment method and the condition of the other incentive payment method occurs, it is simply necessary to perform these methods by making priority settings for the payment methods, for example.

(12) In the above-described embodiment, a supply of the electric power from the mobile unit 400 is performed only at a point in time at which the amount of electric power used by the facility 200 is about to exceed the contract amount of electric power, but the embodiment is not limited thereto.

The electric power may be supplied to the outside of the mobile unit 400 at another point of time, for example, even at a point in time at which the amount of electric power used by the facility 200 is not about to exceed the contract amount of electric power. For example, the controller circuitry 110 may give an instruction to the electric power switching section 430 of the mobile unit 400 to set the supply destination of the electric power to the outside of the mobile unit 400 (for example, the facility 200) on the condition that the amount of stored electricity of the electricity storage device 420 of the mobile unit 400 is larger than or equal to the lower limit amount of stored electricity, the first amount of stored electricity, or the second amount of stored electricity. This may be performed irrespective of whether the first mode or the second mode is selected.

Moreover, an incentive may be paid in accordance with the supply. Furthermore, in this case, the mobile unit 400 may sell the electric power to the electric power system via the facility 200. In addition, when the electric power is supplied to the facility 200, the electric power management device 100 may determine whether the supply is permitted or rejected and perform the permission or rejection of the supply of the electric power on the mobile unit 400.

(13) In the above-described embodiment, when the second mode is selected and the amount of electric power used by the facility 200 is about to exceed the contract amount of electric power, the electric power is supplied from the mobile unit 400 to the outside of the mobile unit 400 if the owner of the mobile unit 400 permits an electric power supply, but the embodiment is not limited thereto.

When the second mode is selected and the amount of electric power used by the facility 200 is about to exceed the contract amount of electric power, the electric power may be supplied from the mobile unit 400 to the outside of the mobile unit 400 irrespective of the presence or absence of permission from the owner of the mobile unit 400.

(14) In the above-described embodiment, the supply destination of the generated electric power of the power generator 410 is set to the electricity storage device 420 or the facility 200, but the embodiment is not limited thereto. The generated electric power of the power generator 410 may be supplied to other devices as long as the devices are devices that consume the electric power. For example, the generated electric power of the power generator 410 may be supplied to a car-mounted device (for example, an air-conditioner) of the mobile unit 400.

Moreover, a communication function of performing communication with the portable terminal of the owner may be further provided in the mobile unit 400 and a supply destination of the generated electric power of the power generator 410 may be determined in accordance with an instruction from the portable terminal of the owner, and, as the supply destination, the above-described car-mounted device may be designated in addition to the electricity storage device 420 and the facility 200.

(15) In the above-described embodiment, when the amount of electric power which is monitored by the power usage monitoring section 220 is about to exceed the contract amount of electric power, the electric power management device 100 receives an electric power supply from the mobile unit 400, but the embodiment is not limited thereto. If a point in time at which a peak of the use of the electric power occurs is previously known in the facility 200, it may be configured such that an electric power supply from the mobile unit 400 may be received in that time period (for example, a time period from 13:00 to 14:00 of a day or a service time period depicted in FIGS. 5A and 5B).

(16) In the above-described embodiment, an example in which the electric power is supplied to the facility 200 from the mobile unit 400 in accordance with the setting of the first mode or the second mode has been described. At this time, irrespective of the mode setting, the electric power may be supplied to the mobile unit 400 from the facility 200 and the electricity storage device 420 of the mobile unit 400 may be charged therewith. At the time of charge of the electricity storage device 420 of the mobile unit 400 from the electric power system, the amount of charge performed by the facility 200 on each mobile unit 400 by using the electric power system is stored. Then, when the amount of electric power used in the facility 200 is greater than or equal to a threshold value which is smaller than the contract amount of electric power, the electric power management device 100 may make each mobile unit 400 supply the electric power to the facility apparatus 210 with an amount supplied to each mobile unit 400 from the electric power system being set as an upper limit by referring to the information on the stored amount of charge from the electric power system for each mobile unit 400.

(17) Each functional section of the electric power management device 100 and each functional section of the mobile unit 400 of the above-described embodiment may be implemented as a circuit that performs the function thereof or may be implemented as a result of a program being performed by one or a plurality of processors. Moreover, a reverse current monitoring device of the above-described embodiment may be configured as a package of an integrated circuit (IC), large scale integration (LSI), and other integrated circuits. This package is used by being incorporated into various devices, and the various devices implement the functions depicted in each embodiment.

Incidentally, the functional blocks are typically implemented as LSI which is an integrated circuit. These functional blocks may be individually implemented as one chip or may be implemented as one chip in such a way as to include part or all of the functional blocks. The name “LSI” is used here, but, depending on the difference in the degree of integration, it is sometimes called an IC, system LSI, super LSI, or ultra LSI. Furthermore, the technique of circuit integration is not limited to LSI, and circuit integration may be implemented by a dedicated circuit or a general-purpose processor. A field programmable gate array (FPGA) that is programmable after LSI is produced and a reconfigurable processor that allows the connection and settings of circuit cells in LSI to be reconfigured after the LSI is produced may be used.

(18) A control program formed of a program code, the control program for making a processor of the electric power management device 100 or the like and various circuits connected to the processor perform the electric power control processing or the like (see FIG. 7) of the mobile unit 400 performed by the electric power management device 100 depicted in the above-described embodiment, can also be recorded on a recording medium or distributed via various communication paths or the like. Such recording media include an IC card, a hard disk, an optical disk, a flexible disk, ROM, and so forth. The distributed control program is used by being stored in a memory or the like from which the control program can be read by the processor, and, as a result of the processor performing the control program, the various functions depicted in the embodiment are implemented.

### <Supplementary Explanation>

Hereinafter, an aspect of the electric power management device according to this embodiment and the effect thereof will be described.

A first aspect of the present disclosure provides an electric power management system including an electric power management device that is provided in a facility connected to an electric power system and connects to a mobile unit provided with a power generator and an electricity storage device, the electric power management device including: a first receiver operative to accept an instruction for selecting one of a first mode in which generated electric power of the power generator is preferentially supplied to an outside of the mobile unit and a second mode in which the electricity storage device is preferentially charged with the generated electric power of the power generator; and control circuitry operative to change a supply destination of the generated electric power of the power generator in accordance with the instruction accepted by the first receiver, the instruction indicating the first mode or the second mode.

As a result, since the electric power management device can supply the generated electric power of the mobile unit provided with the power generator to the facility, the convenience of the operation of the facility is increased.

A second aspect of the present disclosure provides, in the first aspect described above, the electric power management system in which the electric power management device may further include: a detector operative to detect connection with the mobile unit; a display controller operative to make a display of an external device display a screen that accepts an instruction for selecting one of the first mode and the second mode when the detector detects connection of the mobile unit; and a communicator operative to perform communication with an electric power generation controller controlling a supply destination of the generated electric power of the power generator incorporated into the mobile unit, and, based on the mode selected via the external device, the controller circuitry may send an instruction about the supply destination of the generated electric power to the electric power generation controller via the communicator.

As a result, the electric power management device can control the supply destination of the generated electric power of the power generator of the mobile unit in accordance with the accepted mode.

A third aspect of the present disclosure provides, in the second aspect described above, the electric power management system in which the electric power management device may further include a first acquirer operative to acquire a remaining battery level of the electricity storage device of the mobile unit and, when the amount of stored electricity of the electricity storage device of the mobile unit in which the second mode is selected, acquired by the first acquirer, is greater than or equal to a predetermined threshold value, the control circuitry may change the supply destination of the generated electric power of the power generator to at least one of the facility and the electric power system.

As a result, even when the second mode is selected, if the amount of stored electricity is larger than or equal to the amount of stored electricity at which an electric power supply can be performed to the outside of the mobile unit, it is possible to supply the electric power appropriately to the outside of the mobile unit. Here, the above-described predetermined threshold value is the above-described second amount of stored electricity.

A fourth aspect of the present disclosure provides, in the second aspect described above, the electric power management system in which the electric power management device may further include a detector operative to detect the amount of electric power which is used by the facility and, when the amount of electric power detected by the detector is greater than or equal to a threshold value which is smaller than a contract amount of electric power of the facility, the control circuitry may change, to the facility, the supply destination of the generated electric power of the power generator of the mobile unit in which the second mode is selected.

As a result, since the electric power management device can suppress the peak electric power in the facility, it is possible to suppress an increase in the utility rate of the electric power system of the facility.

A fifth aspect of the present disclosure provides, in the fourth aspect described above, the electric power management system in which the electric power management device may further include a second receiver operative to accept an instruction indicating whether a supply of the generated electric power of the power generator to the facility is permitted or not when the amount of electric power detected by the detector is greater than or equal to the threshold value and, only when the instruction of permission is accepted by the second receiver, the control circuitry may change, to the facility, the supply destination of the generated electric power of the power generator of the mobile unit in which the second mode is selected when the amount of electric power detected by the detector is greater than or equal to the threshold value.

As a result, the facility can be supplied with the electric power from the mobile unit at a point in time at which the electric power is needed in the facility by obtaining permission from the owner of the mobile unit.

A sixth aspect of the present disclosure provides, in the fourth aspect described above, the electric power management system in which the electric power management device may further include a first acquirer operative to acquire a remaining battery level of the electricity storage device of the mobile unit connected to the electric power management device and, when the mobile unit includes a plurality of mobile units and the mobile units are connected to the electric power management device, the control circuitry may change the supply destination of the generated electric power of the power generator of a mobile unit of the mobile units to the facility, the mobile unit with the electricity storage device whose amount of stored electricity acquired by the first acquirer is larger than the amounts of stored electricity of the other mobile units, before a mobile unit with the electricity storage device having a smaller amount of stored electricity.

As a result, when a plurality of mobile units are connected, the electric power management device selects, from among the mobile units, a mobile unit with a higher remaining battery level and changes the supply destination of the electric power thereof to the facility, it is possible to prevent as much as possible a situation in which, since a supply of the electric power is received from a mobile unit with a lower remaining battery level, the mobile unit cannot arrive at the destination.

A seventh aspect of the present disclosure provides, in the fourth aspect described above, the electric power management system in which, when the amount of electric power detected by the detector is greater than or equal to the threshold value, the control circuitry may make the electricity storage device of the mobile unit in which the second mode is selected discharge within a range of the amount of charge performed on the electricity storage device from the electric power system and supply the discharged electric power to the facility.

As a result, when the electricity storage device of the mobile unit is charged by using the electric power system from the electric power management device, it is possible to receive a supply corresponding to the amount of charge and use the supply to operate the facility. Since this amount corresponding to the received power is electric power originally supplied from the electric power management device's side, even when the facility is supplied with the corresponding amount of electric power, it is possible to make the owner of the mobile unit less discontented.

An eighth aspect of the present disclosure provides, in the first aspect described above, the electric power management system in which the electric power management device may further include a payer operative to pay an incentive to an owner of the mobile unit when the generated electric power of the power generator is supplied to the facility.

As a result, the owner of the mobile unit can receive the incentive when the mobile unit supplies the electric power to the facility. By paying the incentive to the owner of the mobile unit, the facility can expect that the owner of the mobile unit will use the facility again.

A ninth aspect of the present disclosure provides, in the eighth aspect described above, the electric power management system in which the electric power management device may further include an acceptor operative to accept a designation of a payment method which is performed when the incentive is paid to the owner of the mobile unit and the payer may pay the incentive by the payment method accepted by the acceptor.

As a result, the owner of the mobile unit can accept the incentive in a desired form of the owner of the mobile unit from a plurality of payment methods.

A tenth aspect of the present disclosure provides, in the first aspect described above, the electric power management system in which the electric power management device may further include a second acquirer operative to acquire the position of an owner of the mobile unit and, based on the position of the owner acquired by the second acquirer, the control circuitry may supply, to the facility, the generated electric power from the power generator of the mobile unit of the owner who is present outside the range of the facility before the generated electric power from the power generator of the mobile unit of the owner who is present within the range of the facility. The communicator 150 may function as the second acquirer.

As a result, a supply of the electric power can be received preferentially from the mobile unit of the owner who is not the user of the facility. Therefore, since the electric power of the mobile unit of the user of the facility is left in each electricity storage device, it is possible to reduce the burden on the user of the facility as much as possible in the movement using the mobile unit.

An eleventh aspect of the present disclosure provides, in the eighth aspect described above, the electric power management system in which the electric power management device may further include a second acquirer operative to acquire the position of the owner of the mobile unit and the payer may pay a smaller amount of the incentive when the position of the owner acquired by the second acquirer is present outside the range of the facility than when the position of the owner acquired by the second acquirer is present within the range of the facility.

As a result, since more incentives are paid to the user of the facility than to the non-user of the facility, the owner of the mobile unit develops a desire to use the facility more frequently.

A twelfth aspect of the present disclosure provides, in the second aspect described above, the electric power management system in which the first receiver may accept the charge-to-discharge ratio of the electricity storage device of the mobile unit, the ratio input by the owner of the mobile unit via the external device, and the control circuitry may determine that the mode is the first mode if the ratio of discharge is high and determine that the mode is the second mode if the ratio of charge is high.

As a result, the electric power management device can make determination whether the mode is the first mode or the second mode in accordance with the ratio between charge and discharge, the ratio input by the owner of the mobile unit in accordance with the mood of the owner.

A thirteenth aspect of the present disclosure provides, in the first aspect described above, the electric power management system in which the power generator may be a photovoltaic power generating system using photovoltaic power generation.

As a result, the mobile unit can use the so-called photovoltaic power generating system as the power generator.

A fourteenth aspect of the present disclosure provides, in the first aspect described above, the electric power management system in which the power generator may be a fuel cell and the power generator may generate electric power by being supplied with fuel from the facility connected thereto.

As a result, the mobile unit can use the so-called fuel cell as the power generator.

A fifteenth aspect of the present disclosure provides, in the first aspect described above, the electric power management system in which the electric power management device may further include a first power feeder operative to feed electric power of the electric power system to the electricity storage device via the communicator.

As a result, the electricity storage device of the mobile unit can also be charged by the electric power system supplied to the facility.

A sixteenth aspect of the present disclosure is a mobile unit control method which is performed by an electric power management device that is provided in a facility connected to an electric power system and connects to a mobile unit provided with a power generator and an electricity storage device, the control method including: accepting an instruction for selecting one of a first mode in which generated electric power of the power generator is preferentially supplied to an outside of the mobile unit and a second mode in which the electricity storage device is preferentially charged with the generated electric power of the power generator; and changing a supply destination of the generated electric power of the power generator in accordance with the instruction.

As a result, since the electric power management device can supply the generated electric power of the mobile unit provided with the power generator to the facility, the convenience of the operation of the facility is increased.

A seventeenth aspect of the present disclosure is a mobile unit provided with a power generator and an electricity storage device, the mobile unit including: a connector operative to electrically connect a facility connected to an electric power system and the power generator and makes a supply of generated electric power of the power generator to the facility possible; a second power feeder operative to supply the generated electric power of the power generator to the facility; a charger operative to charge the electricity storage device with the generated electric power of the power generator; and a switcher operative to switch a supply destination of the generated electric power of the power generator in accordance with an instruction from the facility.

The electric power management device according to the present disclosure can be used in a facility, for example, an amusement park, which is used by many users after parking mobile units such as cars therein as the electric power management device that can use a power generator of the mobile unit for the facility.

What is claimed is:

1. An electric power management device that is provided in a facility connected to an electric power system and connects to a mobile unit provided with a power generator and an electricity storage device, the electric power management device comprising:
a first receiver operative to accept an instruction for selecting one of a first mode in which generated electric power of the power generator is preferentially supplied to an outside of the mobile unit and a second mode in which the electricity storage device is preferentially charged with the generated electric power of the power generator; and
control circuitry operative to change a supply destination of the generated electric power of the power generator in accordance with the instruction accepted by the first receiver.

2. The electric power management device according to claim 1, further comprising:
a detector operative to detect connection with the mobile unit;
display control circuitry operative to make a display of an external device display a screen that accepts an instruction for selecting one of the first mode and the second mode when the detector detects connection of the mobile unit; and
a communicator operative to perform communication with an electric power generation controller controlling a supply destination of the generated electric power of the power generator incorporated into the mobile unit, wherein
based on the mode selected via the external device, the control circuitry sends an instruction about the supply destination of the generated electric power to the electric power generation controller via the communicator.

3. The electric power management device according to claim 2, further comprising:
a first acquirer operative to acquire an amount of stored electricity of the electricity storage device of the mobile unit, wherein
when an amount of stored electricity of the electricity storage device of the mobile unit in which the second mode is selected, acquired by the first acquirer, is greater than or equal to a predetermined threshold value, the control circuitry changes the supply destination of the generated electric power of the power generator to at least one of the facility and an electric power system.

4. The electric power management device according to claim 2, further comprising:
a detector operative to detect an amount of electric power which is used by the facility, wherein
when the amount of electric power detected by the detector is greater than or equal to a threshold value which is smaller than a contract amount of electric power of the facility, the control circuitry changes, to the facility, the supply destination of the generated electric power of the power generator of the mobile unit in which the second mode is selected.

5. The electric power management device according to claim 4, further comprising:
a second receiver operative to accept an instruction indicating whether a supply of the generated electric power of the power generator to the facility is permitted or not when the amount of electric power detected by the detector is greater than or equal to the threshold value, wherein
only when the instruction of permission is accepted by the second receiver, the control circuitry changes, to the facility, the supply destination of the generated electric power of the power generator of the mobile unit in which the second mode is selected when the amount of electric power detected by the detector is greater than or equal to the threshold value.

6. The electric power management device according to claim 4, further comprising:
a first acquirer operative to acquire an amount of stored electricity of the electricity storage device of the mobile unit connected to the electric power management device, wherein
when the mobile unit includes a plurality of mobile units and the mobile units are connected to the electric power management device, the control circuitry changes the supply destination of the generated electric power of the power generator of a mobile unit of the mobile units to the facility, the mobile unit with the electricity storage device whose amount of stored electricity acquired by the first acquirer is larger than the amounts of stored electricity of the other mobile units, before a mobile unit with the electricity storage device having a smaller amount of stored electricity.

7. The electric power management device according to claim 4, wherein
when the amount of electric power detected by the detector is greater than or equal to the threshold value, the control circuitry makes the electricity storage device of the mobile unit in which the second mode is selected discharge within a range of the amount of charge performed on the electricity storage device from the electric power system and supplies the discharged electric power to the facility.

8. The electric power management device according to claim 1, further comprising:
a payer operative to pay an incentive to an owner of the mobile unit when the generated electric power of the power generator is supplied to the facility.

9. The electric power management device according to claim 8, further comprising:
an acceptor operative to accept a designation of a payment method which is performed when the incentive is paid to the owner of the mobile unit, wherein
the payer pays the incentive by the payment method accepted by the acceptor.

10. The electric power management device according to claim 1, further comprising:
a second acquirer operative to acquire a position of an owner of the mobile unit, wherein
based on the position of the owner acquired by the second acquirer, the control circuitry supplies, to the facility, the generated electric power from the power generator of the mobile unit of the owner who is present outside a range of the facility before the generated electric power from the power generator of the mobile unit of the owner who is present within the range of the facility.

11. The electric power management device according to claim 8, further comprising:
a second acquirer operative to acquire a position of the owner of the mobile unit, wherein
the payer pays a smaller amount of the incentive when the position of the owner acquired by the second acquirer is present outside the range of the facility than when the position of the owner acquired by the second acquirer is present within the range of the facility.

12. The electric power management device according to claim 2, wherein
the first receiver accepts a charge-to-discharge ratio of the electricity storage device of the mobile unit, the ratio input by the owner of the mobile unit via the external device, and the control circuitry determines that the mode is the first mode if the ratio of discharge is high and determines that the mode is the second mode if the ratio of charge is high.

13. The electric power management device according to claim 1, wherein
the power generator is a photovoltaic power generating system using photovoltaic power generation.

14. The electric power management device according to claim 1, wherein
the power generator is a fuel cell, and
the power generator generates electric power by being supplied with fuel containing hydrogen from the facility which is connected to the electric power management device.

15. The electric power management device according to claim 1, further comprising:
a first power feeder operative to feed electric power of the electric power system to the electricity storage device.

16. A mobile unit control method which is performed by an electric power management device that is provided in a facility connected to an electric power system and connects to a mobile unit provided with a power generator and an electricity storage device, the control method comprising:
accepting an instruction for selecting one of a first mode in which generated electric power of the power generator is preferentially supplied to an outside of the mobile unit and a second mode in which the electricity storage device is preferentially charged with the generated electric power of the power generator; and
changing a supply destination of the generated electric power of the power generator in accordance with the instruction.

17. A mobile unit provided with a power generator and an electricity storage device, the mobile unit comprising:
a connector operative to electrically connect a facility connected to an electric power system and the power generator and makes a supply of generated electric power of the power generator to the facility possible;
a second power feeder operative to supply the generated electric power of the power generator to the facility;
a charger operative to charge the electricity storage device with the generated electric power of the power generator; and
a switcher operative to switch a supply destination of the generated electric power of the power generator in accordance with an instruction from the facility.
